(19) United States
(12) Patent Application Publication
(10) Pub. No.: US 2016/0014249 A1
(43) Pub. Date: Jan. 14, 2016

(54) Supervisory headset mobile communication system

(71) Applicants: Ohanes D. Ghazarian, Henderson, NV (US); John Patrick Ghazarian, Carpinteria, CA (US)

(72) Inventors: Ohanes D. Ghazarian, Henderson, NV (US); John Patrick Ghazarian, Carpinteria, CA (US)

(21) Appl. No.: 14/120,895

(22) Filed: Jul. 8, 2014

(51) Int. Cl. H04M 1/60

(52) U.S. Cl. CPC H04M 1/6058

(57) ABSTRACT

A supervisory mobile communication headset system comprises of a first mobile communication device and a mobile headset, each having an RF transceiver used to establish RF audio and RF supervisory communication between the first mobile communication device and the mobile headset, wherein when both devises carried by the user are within near communication proximity of the other. When the mobile communication device moves away from communication proximity of the headset, the first mobile communication device in response to RF communication signal lose, generates warning alarm signal(s) to remind the user to carry the mobile headset. The mobile communication device may securely be attached to the user limp with removal tamper detection circuitry. Further the mobile communication device may contain a positioning locator receiver used for a monitoring station to track the location of the mobile communication device, and establish communication with the headset user;

This application is continuation of prior application Ser. No. 13/385,848 filed on Mar. 08, 2012, benefits US Provisional application No. 61/630,191 filed on Dec. 5, 2011

### BACKGROUND OF THE INVENTION

In the past headset or ear sets were designed to use with mobile communication devices, but in many instances individuals forget to carry the headset with them which then caused inconvenience for the user not be able to use their headset devices. But recently with new governing laws, which forbids individuals using mobile communication devices during operating a vehicle without the use of a hands free headset device, to allow the driver to have two hands on the vehicle steering wheel when using a mobile communication device, and avoid abstraction.

Also many offender tracking system attached to an offender limb, wherein the tracking device contained a cellular or satellite module, a speaker and a microphone, used for a monitoring station operator to call in to establish conversation with an offender. Unfortunately in this case the monitoring station conversation will be broadcasted over the tracking device speaker, thus every one located near by the offender will be able to hear the conversation, such known systems violates offender's privacy.

It is accordingly primary objective of the present invention to provide a wireless headset used with a supervisory mobile communication system which is designed to remind the user to carry on the wireless headset with the mobile communication device to ascertain the user safely use the mobile communication device in hands free mode during operating a vehicle, or when the person using the mobile communication device desires to have a hands free private communication with other communication device user(s).

It is accordingly another objective of the present invention to provide a wireless headset used with a supervisory mobile communication system which is designed to remind the user to carry on both the wireless headset and the mobile communication device to ascertain the user while driving a vehicle can safely use the mobile communication device in hands free mode, or when the user desires to have a hands free private communication with other communication device user(s).

It is further objective of the present invention utilizes a wireless headset which may be used with a POSITIONING LOCATOR mobile communication device, wherein the POSITIONING LOCATOR mobile communication device contains a GPS receiver used to receive global position signals from orbiting satellites, or uses cellular/RF radio transceiver to receive signals from cell/radio tower sites to coordinate the POSITIONING LOCATOR mobile communication device location, and the cellular, RF or satellite communication module used to establish communication with a monitoring station. Whereas the POSITIONING LOCATOR mobile communication device is securely attached to the person's (Offender) limb containing a short range RF transceiver used to establish RF audio communication and RF supervisory communication with the person wireless headset, Wherein when the person to be monitored moves a preset distance away from the communication proximity of the wireless headset, the POSITIONING LOCATOR mobile communication device in response to RF communication signal lose with the wireless headset, generates signal(s) to remind the person to be monitored to carry on the wireless headset, to ascertain the person to be monitored carry the wireless headset all the time and not walk away without the headset device.

It is further objective of the present invention that provides a wireless headset which may be used with a POSITIONING LOCATOR mobile communication device attached to a person to be monitored used to establish private conversation between a monitoring station operator and the person to be monitored. And the present invention headset or ear-set may be hard wire connected to a POSITIONING LOCATOR mobile communication device to establish a private conversation between a monitoring station operator and a person to be monitored. Herein describe as;

### SUMMARY OF THE INVENTION

A supervisory mobile communication headset system comprises of a first mobile communication device and a wireless headset, each having an RF transceiver configured to establish RF audio or RF audio and RF supervisory communication between the first mobile communication device and the wireless headset, wherein when both devices carried on by the user are within near proximity of the other. Whereas the first mobile communication device is configured to establish RF audio or RF audio and data communication in between the headset and at least one or more plurality of secondary communication devices, the system comprises;

a wireless headset or a ear set housing containing a battery as power supply;

a processor,

a speaker and a microphone;

an RF transceiver used for establishing short range RF audio and RF supervisory communication with a first mobile communication device; and

a first mobile communication device having a battery as power supply

a processor coupled to an alerting device circuitry;

a RF transceiver(s) used to establish short range RF audio or RF audio and RF supervisory communication with the wireless headset;

a second RF transceiver used for establishing RF audio or RF audio and data communication with at least one or more secondary communication device(s);

The first mobile communication device processor configured to activate the first mobile communication device alerting circuitry to indicate to the user the wireless headset device is beyond communication range of the first mobile communication device, wherein when the supervisory communication signal(s) are lost in between the wireless headset and the first mobile communication device.

The supervisory mobile communication headset system of the present invention first mobile communication processor further is configured to activate the alerting device circuitry to warn the user the wireless headset power may be off, wherein when the supervisory communication confirmation signal(s) become lost in between the wireless headset and the first mobile communication device.

The supervisory mobile communication headset of the present invention processor is connected to a alerting device circuitry, the wireless headset processor configured to activate the headset alerting device circuitry to indicate to the user the wireless headset is beyond communication range of the first mobile communication device or the first mobile communication device power may be off, wherein when the supervisory communication confirmation signal(s) are lost in between the wireless headset and the first mobile communication device.

The supervisory mobile communication wireless headset configured to communicate with RF audio signals and may communicate with RF supervisory signals with a first mobile communication device, which is securely attached to a person limb using a tamper detection circuitry to ascertain the user carry on the first mobile communication device. The first mobile communication device is configured to establish RF audio communication between the headset device and at least one or more plurality of other secondary communication devices, the system comprises;

a wireless headset housing containing a battery used as power supply;

a processor;

a speaker and a microphone;

an RF transceiver(s) used for establishing short range RF audio or RF audio and RF supervisory communication with the first mobile communication device; and

a first mobile communication device having a battery as power supply

a processor coupled to an alerting device circuitry;

a RF transceiver(s) used to establish short range RF audio and RF supervisory communication with the wireless headset;

a second RF transceiver used for establishing RF audio or RF audio and data communication with plurality of other secondary communication device(s)

The first mobile communication device processor configured to activate the alerting device circuitry to indicate to the user the wireless headset unit is beyond communication range of the first mobile communication device or the headset power may be off, when the supervisory communication confirmation signal(s) become lost in between the wireless headset and the first mobile communication device.

The supervisory mobile communication headset system of the present invention first mobile communication device processor activates the first mobile communication device alerting circuitry to indicate the supervisory communication signal loss between the wireless headset and the first mobile communication device, and the first mobile communication device processor activates the first mobile communication device alerting circuitry for a second time when the supervisory communication signal(s) becomes connected between the wireless headset and the first mobile communication device, the second alert being distinct from the first alert.

The supervisory mobile communication headset system of the present invention wireless headset processor activates the headset alerting device to indicate the supervisory communication signal loss between the headset and the first mobile communication device, and the wireless headset processor activates the headset alerting device circuitry for second time when the supervisory communication signal(s) becomes connected between the wireless headset and the first mobile communication device, the second alert being distinct from the first alert.

The supervisory mobile communication headset system of the present invention first mobile communication device may have a POSITIONING LOCATOR receiver to send the first mobile communication device location information by wirelessly means to a monitoring station, and the POSITIONING LOCATOR mobile communication device is attached to a person limb with a tamper detection circuitry to ascertain the person to be monitored is carrying the POSITIONING LOCATOR mobile communication device all the time. The POSITIONING LOCATOR mobile communication device processor configured to activate the POSITIONING LOCATOR mobile communication device alerting circuitry indicative of the wireless headset device is beyond communication range of the POSITIONING LOCATOR mobile communication device, wherein when the supervisory communication confirmation signal(s) are lost in between the wireless headset and the POSITIONING LOCATOR mobile communication device, and

the POSITIONING LOCATOR mobile communication device processor in response to detecting POSITIONING LOCATOR mobile communication device tamper or removal from the person limb, the POSITIONING LOCATOR mobile communication device RF transceiver wirelessly transmits at least one signal to a monitoring station communication device(s) containing information to the POSITIONING LOCATOR mobile communication device tamper detection along with the POSITIONING LOCATOR mobile communication device ID information, and POSITIONING LOCATOR mobile communication device location information.

The supervisory mobile communication headset system of the present invention supervisory RF communication signal(s) may contain low battery detection signal(s), the first mobile communication device processor in response to received low battery detection signal from the wireless headset device, the first mobile communication device activates the alerting device circuitry to warn the user the headset battery condition is low;

The supervisory RF communication signal(s) may contain low battery detection signal(s), in which the wireless headset in response to received low battery detection signal from the first mobile communication device activates the headset alerting device circuitry to warn the user the first mobile communication device battery condition is low.

The supervisory mobile communication wireless headset and first mobile communication device generated signals are audio, verbal, visual, alphanumeric, symbol(s) or icon(s) and my be of vibrating signals or by other signaling means, used to alert the user to carry both the headset and the mobile communication device to ascertain the user have the access to the use of the wireless headset with the first mobile communication device or POSITIONING LOCATOR mobile communication device at all time, and the alerting device circuitry generated signals may be used to indicate low battery condition of the wireless headset or to the first mobile communication device.

### BRIEF DESCRIPTION OF THE DRAWINGS

FIG. 1 Is a drawing of user supervisory headset or ear set, a mobile communication device, and offender tracking device.

FIG. 2 Is the Block Diagram

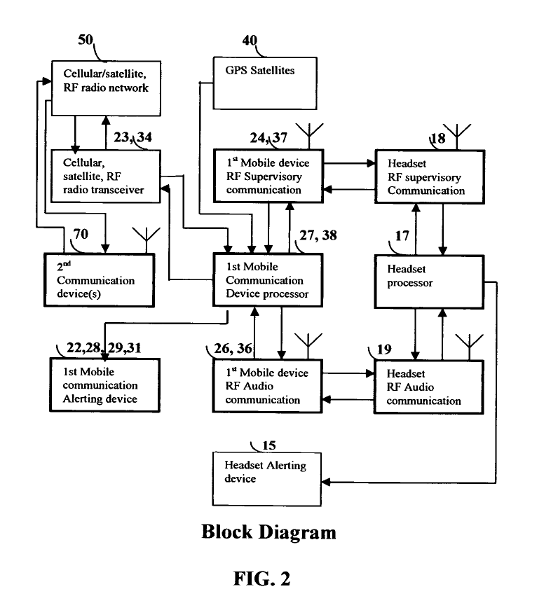

### DETAILED DESCRIPTION OF THE INVENTION

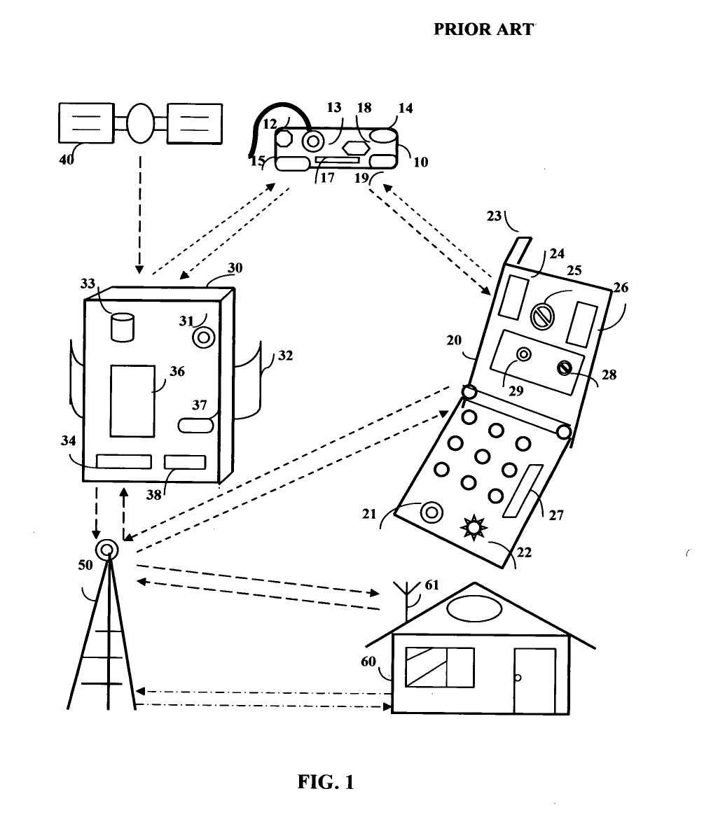

A supervisory mobile communication headset system FIG. 1 utilizing a user carry on first mobile wireless communication device 20 and a mobile wireless headset device 10, each one of the devices 10, 20 having an RF transceiver configured to establish RF audio 19, 26 and RF supervisory 18, 24 communication between the first mobile communication device 20 and the mobile wireless headset device 10, wherein when both devices 10, 20 are within near proximity of the other, the system comprises;

a wireless headset 10 or a ear set 10 housing containing a battery 14 as power supply, a processor 17, a speaker 13 and a microphone 12, an RF transceiver 18, 19 used for establishing short range RF audio and RF supervisory communication with the first mobile communication device 20.

And a first mobile communication device 20 having a battery or other power supply means as power supply, a processor 27 coupled to an alerting device(s) 22, 28, 29 circuitry;

an RF transceiver(s) 24, 26 used to establish short range RF audio and RF supervisory communication with said wireless headset 10;

a second RF transceiver 23 used for establishing RF audio or data communication with at least one or more plurality of secondary communication device(s) 60, 61 which may use land line or other wireless communication means;

The first mobile communication device 20 processor 27 is configured to activate the first mobile communication device 20 alerting circuitry 22, 28, 29 indicative of the wireless headset device 10 is beyond communication range of the first mobile communication device 20 wherein when the supervisory communication confirmation signal(s) 18, 24 are lost in between the wireless headset 10 and the first mobile communication device 20.

The supervisory mobile communication headset system of the present invention first mobile communication device 20 processor 27 further is configured to activate the mobile communication device 20 alerting circuitry 22, 28, 29 to warn the user the wireless headset 10 power may be off wherein, when the supervisory communication confirmation signal(s) 18, 24 become lost in between the wireless headset 10 and the first mobile communication device 20.

the supervisory mobile communication headset system first mobile communication device 20 processor 27 further is configured to activate the mobile communication device 20 alerting circuitry 22, 28, 29 in response to receiving low battery condition signal from the wireless headset device 10.

The supervisory mobile communication headset system first mobile communication device 30 is securely attached by a strap 32 to a person limp having a tamper detection circuitry to ascertain the user carry on the first mobile communication device 30, the first mobile communication device is configured to establish RF audio or data communication through an cell, satellite, LAN, WAN, Internet etc. 50 with at least one or more plurality of other secondary communication devices 60, 61.

The supervisory mobile communication headset system first mobile communication device 20 processor 27 activates the first mobile communication device 20 alerting circuitry 22, 28, 29 to indicate the supervisory communication signal loss between the wireless headset 10 and the first mobile communication device 20, and the first mobile communication device 20 processor 27 activates the alerting device circuitry 22, 28, 29 for a second time when the supervisory communication signals 18, 24 becomes connected between the wireless headset 10 and the first mobile communication device 20, the second alert being distinct from the first alert.

The supervisory mobile communication headset system first mobile communication device 20 generated signals are audio 25, verbal 25, visual 22, alphanumeric, symbol(s) 28, 29 or icon(s) 28, 29 and my be of vibrating signals, or other signaling means used to alert the user to carry the wireless headset device 10 or both the wireless headset 10 and the first mobile communication device 20 to ascertain the user have the access to the use of the wireless headset 10 with the mobile communication device 20 at all time, and the alerting device circuitry generated signal(s) 22, 28, 29 may be used to indicate low battery condition of the wireless headset 10 device.

The supervisory mobile communication headset system of present invention may also be used with POSITIONING LOCATOR mobile communication device 30 which is securely attached by the use of a strap 32 to a person's limp with a tamper detection circuitry, to ascertain POSITIONING LOCATOR mobile communication device 30 is attached to the person to be monitored and to be communicate with, and a wireless headset device 10 is provided to the person to be monitored, each one of the devices 10, 30 having an RF transceiver 18, 19, 36, 37 configured to establish RF audio and RF supervisory communication between the POSITIONING LOCATOR mobile communication device 30 and the wireless headset device 10, wherein when both devices 10, 30 are within near proximity of the other, the system comprises;

a wireless headset 10 or an ear set 10 housing containing a battery 10 as power supply,

a processor 17, a speaker 13 and a microphone 12. RF transceiver 18, 19 used for establishing short range RF audio and RF supervisory communication with the POSITIONING LOCATOR mobile communication device 30;

And a POSITIONING LOCATOR mobile communication device 30 having a battery or other power means as power supply, a processor coupled to an alerting device circuitry 31;

An RF transceiver(s) 36, 37 used to establish short range RF audio and RF supervisory communication with the wireless headset 10;

A second RF transceiver used for establishing RF audio or data communication with at least one or more plurality of secondary communication device(s) 60, 61;

a POSITIONING LOCATOR receiver 33 used to receive global position signals from orbiting satellites 40, or uses cellular, satellite, RF radio module 34 to receive signals from cell/radio tower sites to coordinate the POSITIONING LOCATOR mobile communication device 30 location. The POSITIONING LOCATOR mobile communication device 30 processor 38 configured to activate the POSITIONING LOCATOR mobile communication device 30 alerting circuitry 31 indicative of the wireless headset device 10 is beyond communication range of the POSITIONING LOCATOR mobile communication device 30 wherein when the supervisory communication confirmation signal(s) 18, 37 are lost in between the wireless headset device 10 and the POSITIONING LOCATOR mobile communication device 30.

And the POSITIONING LOCATOR mobile communication device 30 processor 38 in response to detecting the POSITIONING LOCATOR mobile communication device 30 tamper or removal from said person limp, the POSITIONING LOCATOR mobile communication device secondary RF transceiver 34 wirelessly transmits a signal(s) to at least one or more plurality of secondary communication device(s) 60, 61 containing information to the. POSITIONING LOCATOR mobile communication device 30 tamper detection condition with the POSITIONING LOCATOR mobile communication device 30 ID information along with the POSITIONING LOCATOR mobile communication device 30 location information.

the supervisory mobile communication headset system supervisory RF communication signal(s) 18, 37 may contain the wireless headset 10 low battery detection signal(s), the POSITIONING LOCATOR mobile communication device 30 processor 38 in response to received low battery detection signal from the wireless headset 10, the POSITIONING LOCATOR mobile communication device 30 activates the POSITIONING LOCATOR mobile communication device alerting circuitry 31 to warn the user that the wireless headset 10 battery condition is low, or the supervisory RF communication signal(s) may contain low battery detection signal(s) in which the wireless headset 10 in response to received low battery detection signal from the POSITIONING LOCATOR mobile communication device 30 activates the wireless headset 10 alerting device circuitry 15 to warn the user the POSITIONING LOCATOR mobile communication device 30 battery condition is low.

The supervisory mobile communication headset system POSITIONING LOCATOR mobile communication device 30 processor 38 further is configured to activate the POSITIONING LOCATOR mobile communication device 30 alerting circuitry 31 to warn the user the wireless headset 10 power may be off wherein when the supervisory communication confirmation signal(s) 18, 37 become lost in between the wireless headset 30 and the POSITIONING LOCATOR mobile communication device 30. The mobile communication headset 10 or ear-set device may utilize a hardwire connection to connect the headset device 10 or ear set device to the POSITIONING LOCATOR device 30, wherein the mobile communication device activates the alerting circuitry 31 indicative of an incoming call, for the person to be monitored to use the hard wire connected headset or ear-set to answer an incoming call.

The supervisory mobile communication headset system POSITIONING LOCATOR mobile communication device 30 processor 38 activates the POSITIONING LOCATOR mobile communication device 30 alerting circuitry 31 to indicate the supervisory communication signal(s) 18, 37 loss between said wireless headset 10 and said POSITIONING LOCATOR mobile communication device, and the POSITIONING LOCATOR mobile communication device processor 38 activates the alerting device 31 circuitry for a second time when the supervisory communication signal(s) 18, 37 becomes connected between the wireless headset 10 and the POSITIONING LOCATOR mobile communication device 30, the second alert being distinct from the first alert.

The supervisory mobile communication headset system POSITIONING LOCATOR mobile communication device 30 generated signals 31 are audio, verbal, visual, alphanumeric, symbol(s) or icon(s) and my be of vibrating signals, or other signaling means used to alert the user to carry the wireless headset device 10 to ascertain the person to be monitored have access to the use of the wireless headset 10 with the POSITIONING LOCATOR mobile communication device 30 at all time, and the alerting device circuitry generated signal(s) 31 may be used to indicate low battery condition of the wireless headset 10 or to the POSITIONING LOCATOR mobile communication device 30.

The supervisory mobile communication headset system may be utilized with any electronic device without having a secondary RF transceivers to communicate with other secondary communication devices, whereas each one of the devices having an RF transceiver configured to establish RF audio and RF supervisory communication between the electronic device and the wireless headset device, wherein when both devices are within near proximity of the other, the system comprises;

The electronic device processor configured to activate the electronic device alerting circuitry, indicative of the wireless headset device is beyond communication range of the electronic device, wherein when the supervisory communication confirmation signal(s) are lost in between the wireless headset and the electronic device.

1. (canceled)

2. A supervisory mobile communication headset system utilizing a positioning locator mobile communication device securely attached to a person's limp with a tamper detection circuitry to ascertain said positioning locator mobile communication device is attached to said person to be monitored, and
a wireless headset or an ear-set device each one of said devices having an RF transceiver configured to establish RF audio or RF audio and RF supervisory communication between said positioning locator mobile communication device and said wireless headset or ear set device, wherein when both devices are within near proximity of the other, said system comprises;
a wireless headset or an ear-set housing containing a battery or other power means used as power supply,
a processor, a speaker and a microphone,
an RF transceiver used for establishing short range RF audio or RF audio and RF supervisory communication with said positioning locator mobile communication device; and
a positioning locator mobile communication device having a battery or other power means used as power supply,
a processor coupled to an alerting circuitry;
a RF transceiver(s) used to establish short range RF audio or RF audio and RF supervisory communication with said wireless headset;
a second RF transceiver used, for establishing RF audio or RF audio and data communication between said positioning locator mobile communication device and at least one or more plurality of secondary communication device(s); which is used to establish a communication link between said mobile headset device and at least one or more plurality of secondary communication devices;
a positioning locator receiver is configured to receive position signals from GPS satellites or cellular/radio towers, to coordinate said positioning locator mobile communication device location,
said positioning locator mobile communication device processor is configured to activate said positioning locator mobile communication device alerting circuitry indicative of an incoming call for said person to be monitored to answer the incoming call by use of said wireless headset or ear set device,
and said positioning locator mobile communication device processor in response to detecting said positioning locator mobile communication device tamper or removal from said person limp, said positioning locator mobile communication device second RF transceiver wirelessly transmits a signal(s) to at least one or more plurality of secondary communication device(s) containing information to said positioning locator mobile
communication device at least, ID information, tamper detection condition, positioning locator mobile communication device location information, or positioning locator communication device ID information and tamper condition, or positioning locator device ID information and the location information, or positioning locator device ID information and tamper condition along with positioning locator mobile communication device location information.

3. A supervisory mobile communication headset system utilizing a positioning locator mobile communication device securely attached to a person's limp with a tamper detection circuitry to ascertain positioning locator mobile communication device is attached to said person to be monitored, and
a headset device configured to establish audio or RF audio and RF supervisory communication between said positioning locator mobile communication device and said headset device, wherein when said headset device is connected to said mobile communication device, said system comprises;
a headset or an ear-set housing,
a speaker and a microphone,
a wire connector used to connect said headset to said positioning locator mobile communication device to establish RF audio communication with said positioning locator mobile communication device; and
a positioning locator mobile communication device having a battery as power supply, and
a processor coupled to an alerting circuitry,
a second RF transceiver used, for establishing RF audio and data communication between said positioning locator mobile communication device and at least one or more plurality of secondary communication device(s); which is used to establish a communication link between said headset device and at least one or more plurality of secondary communication devices;
a positioning locator receiver used to receive global position signals from orbiting satellites or receiving cellular/radio tower signals to coordinate said positioning locator mobile communication device location,
said positioning locator mobile communication device processor is configured to activate said positioning locator mobile communication device alerting circuitry indicative of an incoming call for said person to be monitored to answer the incoming call by use of said headset or ear set device,
and said positioning locator mobile communication device processor in response to detecting said positioning locator mobile communication device tamper or removal from said person limp, said positioning locator mobile communication device second RF transceiver wirelessly transmits a signal(s) to at least one or more plurality of secondary communication device(s) containing information to said positioning locator mobile
communication device at least, ID information, tamper detection condition, positioning locator mobile communication device location information, or positioning locator communication device ID information and tamper condition, or positioning locator device ID information and the location information, or positioning locator device ID information and tamper condition along with positioning locator mobile communication device location imformation.
